(19) United States
(12) Patent Application Publication
(10) Pub. No.: US 2021/0272470 A1
(43) Pub. Date: Sep. 2, 2021

(54) DIGITAL CRITIQUE APP

(71) Applicant: THE TRUSTEES OF INDIANA UNIVERSITY, Indianapolis, IN (US)

(72) Inventor: Jacob Elton Dobson, Brownsburg, IN (US)

(21) Appl. No.: 16/804,938

(22) Filed: Feb. 28, 2020

(51) Int. Cl. G09B 19/00; G06Q 30/02; H04L 12/18; H04L 12/58; H04L 29/08; G09B 5/00

(52) U.S. Cl. CPC G09B 19/00; G06Q 30/0282; H04L 12/1818; G09B 5/00; H04L 51/046; H04L 51/10; H04L 67/146; H04L 12/1822

(57) ABSTRACT

A system and method for generated nuanced mature data from consensus group evaluation in relative real-time for future use or quantitative analytics. Examples include student progress, business meetings, polling data, coaching sessions, product development, etc. Technologies for generating and managing a critique session include a platform application for receiving a multimedia object and one or more specified terms associated with the multimedia object. The platform application also includes receiving feedback during the critique session regarding the multimedia object and generating analytics based on the feedback. The generated analytics are stored on the server and presented as visualizations on devices connected to the platform application.

### SUMMARY

Evaluation is mandatory in many fields, including art, literature, science, and the like. The process of evaluation is a critique. As an example, art critique in an educational setting allows individuals, such as students, to perceive and interpret works of art as well as develop and improve their own artistic skills. In such a setting, an instructor may conduct a critique with students as a group, during which the group interacts together to analyze a work of art and provide feedback on the work.

Consequently, meaningful critiques in any setting involve providing and receiving proper feedback. A lack of meaningful feedback can result from a lack of clarity and common understanding that underlies the subject being critiqued. In addition, although many courses include an online component for providing critiques, such online critiques often use a message board or survey format in which feedback can arrive individually and much later than desired, which may potentially result in less meaningful feedback.

There has been a lack of context between a reviewer and a reviewee when evaluating design projects. Design rubrics were lacking when critiquing design work and defining project scope that included technique, aesthetics, and meaning. The invention provides a visual rubric that permits the user, such as a student, to visually chart progress and achieve it for future projects and work.

The solution to the above problems was a tool that provides presentation, reference, evaluation, and discussion between one or more reviewers and one or more reviewees in real time. The resulting tool was an app that provided each of these functions on one digital interface that is useful in many settings, e.g., on-line learning, in a classroom, research settings, and product development. In one embodiment, the app could be used by coaches, counselors, and other professionals that interact with those seeking and/or requiring evaluations.

Systems and methods for providing a digital critique platform to generate meaningful analytic data and provide feedback in real-time.

One embodiment is a method that includes transmitting, by a server, a multimedia object (e.g., a video, an image, and/or a document) for critique and one or more terms (e.g., qualities) associated with the multimedia object to an application executing on a device, where the device generates a prompt for the critique that includes the multimedia object and the one or more terms. The method also includes receiving one or more feedback items in response to the prompt from the device, in other words, batching (evaluating more than one multimedia object). The method also generates a plurality of analytics associated with the one or more feedback items, and transmits the plurality of analytics associated with the one or more feedback items.

Another embodiment discloses a server. The system includes a processor and a memory. The memory stores program code, which, when executed on a processor, performs an operation. The operation itself includes transmitting a multimedia object for critique and one or more terms associated with the multimedia object to an application executing on a device, wherein the device generates a prompt for the critique including the multimedia object and the one or more terms. The operation also includes receiving one or more feedback items in response to the prompt from the device. The operation also generally includes generating a plurality of analytics associated with the one or more feedback items. The operation also generally includes transmitting the plurality of analytics associated with the one or more feedback items.

### BRIEF DESCRIPTION OF THE DRAWINGS

FIG. 1 illustrates an example computing environment in which multiple devices engage with an online digital critique platform including a server storing data, a host device starting the review and initiating the evaluation session, and a participant device performing reviewer functions in participating with the app.

FIG. 2 illustrates a block diagram of an example of an embodiment of the platform server described relative to FIG. 1;

FIG. 3 illustrates a block diagram of an example of an embodiment of a user device configured to engage with an online digital critique platform;

FIG. 4 illustrates a flow diagram of an example of an embodiment of a method for creating a critique session through an online digital critique platform;

FIG. 5 illustrates a flow diagram of an example of an embodiment of a method for managing a critique session created through an online digital critique platform;

FIG. 6 illustrates a conceptual diagram of an example of an embodiment of a graphical user interface displayed on a user device for an online digital critique platform;

FIG. 7 illustrates a conceptual diagram of another example of an embodiment of a graphical user interface displayed on a user device for an online digital critique platform;

FIG. 8 illustrates a conceptual diagram of yet another example of an embodiment of a graphical user interface displayed on a user device for an online digital critique platform;

FIG. 9 illustrates a conceptual diagram of still another example of an embodiment of a graphical user interface displayed on a user device for an online digital critique platform;

FIG. 10 illustrates a conceptual diagram of an example of another embodiment of a graphical user interface displayed on a user device for an online digital critique platform; and

FIG. 11 illustrates conceptual diagrams of another example of another embodiment of a graphical user interface displayed on a user device for an online digital critique platform.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

Embodiments presented herein disclose techniques for providing and managing a critique session for relative real-time feedback. More particularly, embodiments disclose a digital critique application platform that allows a user to host an online session for one or more participant users to critique a subject, such as a multimedia object (e.g., an image of a piece of art, audio of a musical performance, video of a medical procedure being performed). The host may also specify one or more terms for participants to use in the critique. These terms can orient the users with a common foundation for evaluating the multimedia object. The application platform may present, to participants connected to the critique session, a user interface that includes the multimedia object, prompts involving the specified terms, and a panel used for discussion with other users in the critique. Participant users may provide feedback by answering the prompts relating to the specified terms and also discussing the object in the panel. The critique application platform receives the feedback from each user and may perform various analytics, including by not limited to tabulating responses matching a given term, aggregating responses, identifying trends across user groups, and so on. As one example, each session using the critique application generates score that is archived. After any number of sessions, the critique application quantifies previous scores to provide analytics. Those analytics may also be archived for a timeline to evaluate larger trends. One non-limiting example is polling data. Where polls provide one-dimensional data, the critique application provides nuanced data through a visualization, such as a real-time radar chart. A radar chart is defined as a graphical method of displaying multivariate data in a two-dimensional chart of three or more quantitative variables represented on axes starting at the same point. The critique application platform may then transmit, to each user, the responses and analytics. The user interface may present the responses and analytics through various manners of visualization, such as charts, graphs, list results, and the like, allowing for further discussion of nuanced data in the chat panel. Nuanced data is defined as data that is more rendered or realized, and that demonstrates subtle data differences. Stated differently, it results in a more mature reading of the data. The platform may then archive the critique session, e.g., for future reference and growth assessment.

Advantageously, the techniques described herein provide a critique platform for dynamic and real-time feedback for a given subject. The platform may store feedback for the subject and act as a source of truth for judging various design, ideas, and performances. In addition, generating prompts based at least in part on pre-defined terminology may allow critique participants to express feedback with one another using a common vernacular. Additionally, the online platform allows participants to remotely engage in a session without having to be physically collocated with one another.

The disclosure uses art critique as a reference example for creating and managing a critique session of a host and participants. However, one of ordinary skill in the art will recognize that the techniques described herein may be adapted to a variety of settings. For example, a digital critique application platform may be deployed in a design agency setting in focus testing a given campaign, e.g., polling data. As another example, the platform may be deployed in a medical education setting to allow students and professionals to evaluate a performance of a given medical procedure. In that sense, it facilitates voices from all participants and thus is an equalizer of data regardless of loud voices, biases, etc.

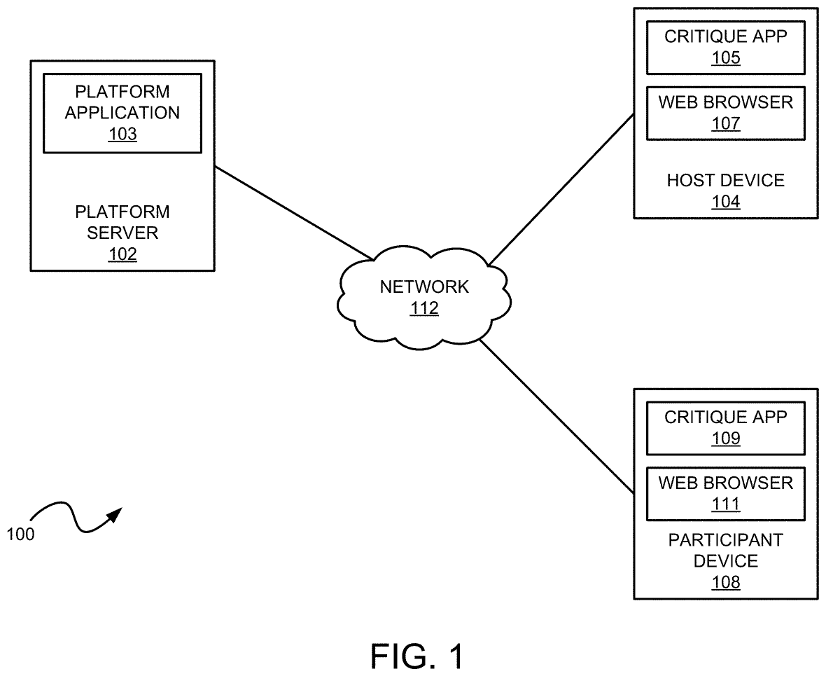

FIG. 1 illustrates an example computing environment 100 for providing an online digital critique application platform. As shown, the computing environment 100 includes a platform server 102, a host device 104, and a participant device 108, each connected with one another via a network 112 (e.g., a local area network, wide area network, the Internet, etc.). In an embodiment, the platform server 102 may be embodied as a physical computing device (e.g., a desktop computer, workstation, laptop computer, tablet computer, etc.) or a virtual computing instance executing on a cloud network. In an embodiment, each of the host device 104 and participant device 108 may be embodied as a physical computing device (e.g., a desktop computer, laptop computer, tablet computer, smartphone or other mobile device, etc.) or a virtual computing instance executing on a cloud network.

Illustratively, the platform server 102 includes a platform application 103. As further described herein, the platform application 103 is a backend server application that allows a user to generate and conduct digital critique sessions in which participants are invited and task provide feedback with regard to a subject, such as a multimedia object uploaded by a host or participant user (e.g., an image, audio, or video, etc.). In conducting digital critique sessions, the platform application 103 transmits session information (e.g., the multimedia object and any associated data for use in the critique) to the host device 104 and participant device 108. The platform server 103 receives feedback and may perform various analytical techniques on the data and send the generated data to the host device 104 and participant device 108.

Further illustratively, the host device 104 includes a critique app 105 and web browser 107, and the participant device 108 includes a critique app 109 and web browser 111. The critique app 105, 109 may be embodied as any front-end application that communicates with the platform application 103. More particularly, the critique app 105, 109 provides a graphical user interface for creating and presenting a critique session with which a user may engage. Based on the communication between the critique app 105,109 and the platform application 103, the digital critique platform allows for relative real-time feedback for a subject to be critiqued. For example, as further described herein, the platform application 103 enables the critique app 105, 109 to provide an open discussion platform with which users thereof may communicate. In addition, the platform application 103 may, based on feedback received from users via the critique app 105, 109, derive various analytics to provide additional data that may be useful for a user. In an embodiment, the critique apps 105, 109 may be accessed at a network location via the respective web browsers 107, 111.

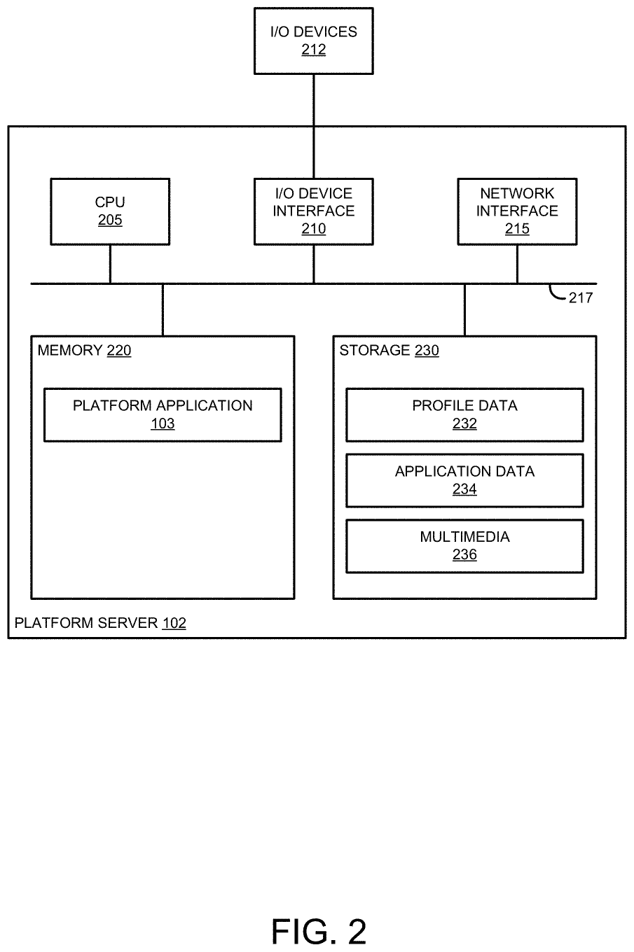

FIG. 2 further illustrates the platform server 102, according to an example embodiment. As shown, the platform server 102 includes, without limitation, a central processing unit (CPU) 205, an I/O device interface 210, a network interface 215, a memory 220, and a storage 230, each interconnected via an interconnect bus 217. Note, CPU 205 is included to be representative of a single CPU, multiple CPUs, a single CPU having multiple processing cores, and the like. Memory 220 is generally included to be representative of a random access memory. Storage 230 may be a disk drive storage device. Although shown as a single unit, storage 230 may be a combination of fixed and/or removable storage devices, such as fixed disc drives, removable memory cards, or optical storage, network attached storage (NAS), or a storage area network (SAN). The I/O device interface 210 may provide a communications interface between the platform application 103 and I/O devices 212. The network interface 215 may be embodied as any hardware or circuitry to enable the platform server 102 to communicate over a network (e.g., the network 112).

Illustratively, the memory 320 includes the platform application 103, which may be embodied as program code to be executed on the CPU 205 to perform an operation including functions described herein. The storage 230 includes profile data 232, application data 234, and multimedia 236. The profile data 232 may be embodied as any data pertaining to a given user, such as critique sessions that the user participated in, whether the user participated in the critique session as a host or a participant user, feedback provided by that user, whether the user is associated with a given subject of a critique session, and the like. The platform application 103 may maintain the profile data 232 and perform general user management tasks on the profile data 232. The platform application 103 may receive input from a user device and modify the corresponding profile data 232 based on the input. The application data 234 may be embodied as any data generated by either the platform application 103 or the critique app on a user device. For example, the application data 234 may correspond to feedback responses collected by the platform application 103 from user devices or analytics generated by the platform application 103 based on the feedback responses. The application data 234 may also include predefined terms sent by a host for a given subject of critique. The application data 234 may be organized, for example, by user profile or by a multimedia object subject to critique. Storing the application data 234 allows the platform application 103 to perform additional analytics, such as evaluating historical data for a given subject and identifying trends based on feedback received by different groups of users. The multimedia 236 may be embodied as any data to be used as a subject of critique. For example, the multimedia 236 may include image data, video data, or audio data. In addition, application data 234 may include metadata characterizing a given multimedia 236, such as tags identifying the type of multimedia as well as predefined terms to associate with the multimedia 236. In an embodiment, the platform application 103 may be implemented under a web application development platform (e.g., Firebase).

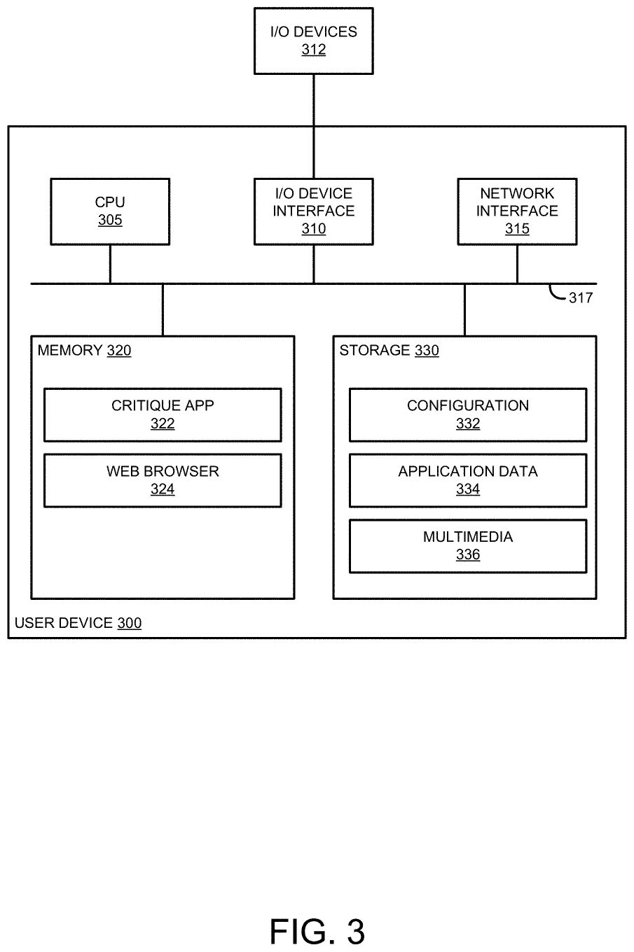

FIG. 3 illustrates a user device 300, according to an example embodiment. The user device 300 may be representative of the host device 104 and participant device 108 described relative to FIG. 1 As shown, the user device 300 includes, without limitation, a central processing unit (CPU) 305, an I/O device interface 310, a network interface 315, a memory 320, and a storage 330, each interconnected via an interconnect bus 317. Note, CPU 305 is included to be representative of a single CPU, multiple CPUs, a single CPU having multiple processing cores, and the like. Memory 320 is generally included to be representative of a random access memory. Storage 330 may be a disk drive storage device. Although shown as a single unit, storage 330 may be a combination of fixed and/or removable storage devices, such as fixed disc drives, removable memory cards, or optical storage, network attached storage (NAS), or a storage area network (SAN). The I/O device interface 310 may provide a communications interface between the user device 300 and I/O devices 312. The network interface 315 may be embodied as any hardware or circuitry to enable the user device 300 to communicate over a network (e.g., the network 112).

Illustratively, the memory 320 includes a critique app 322 and a web browser 324. The critique app 322 and web browser 324 may correspond to the critique app 105, 109 and the web browser 107, 111 of the host device 104 and the participant device 108, respectively. The storage 330 includes a configuration 332, application data 334, and multimedia 336. The configuration 332 may be embodied as any data pertaining to settings established by a user on the critique app 322, such as user profile information, notification information, and the like. The application data 334 may be embodied as any data generated by either the platform application 103 or the critique app 322. For example, the application data 334 may correspond to feedback responses collected by the platform application 103 from user devices or analytics generated by the platform application 103 based on the feedback responses. The application data 334 may also include predefined terms sent by a host for a given subject of critique. The application data 334 may also include visualization data (e.g., charts, graphs, lists) generated by the critique app 322 (or the platform application 103) for presentation on the user interface of the critique app 322. The application data 334 may be organized, for example, by user profile or by a multimedia object subject to critique. Storing the application data 334 allows the platform application 103 to perform additional analytics, such as evaluating historical data for a given subject and identifying trends based on feedback received by different groups of users. Application data 334 may also include chat logs corresponding to discussion during a given critique session. The multimedia 336 may be embodied as any data to be used as a subject of critique. For example, the multimedia 336 may include image data, video data, or audio data. In addition, application data 336 may include metadata characterizing a given multimedia 336, such as tags identifying the type of multimedia as well as predefined terms to associate with the multimedia 336.

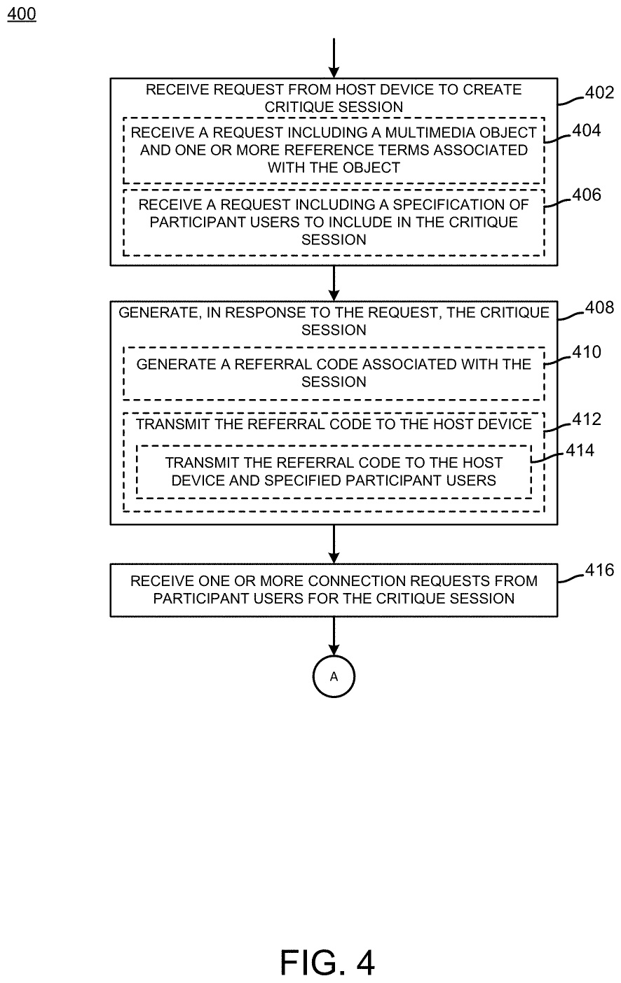

FIG. 4 illustrates a method 400 for creating a critique session based on input received from the host device 104. As shown, the method 400 begins in block 402, in which the platform application 103 receives a request from a host user (via the critique app 105) to create a critique session. For example, in block 404, the request may include a multimedia object (e.g., uploaded with the request or provided as a link to the multimedia object) and one or more reference terms associated with the object. As another example, in block 406, the request may include a specification of participant users (e.g., specified using an e-mail address or username associated with the platform) to include in the critique session. Additionally, the request may also include a specification of a time window during which the session is to occur.

In block 408, the platform application 103 generates, in response to the request, the critique session. Once generated, in block 410, the platform application 103 may generate a referral code or session identifier (e.g., network locator, uniform resource locator, universally unique identifier, and the like) associated with the session. The platform application 103, in block 412, may transmit the referral code to the host device 104. In turn, the host device 104 may transmit the generated referral code to a desired set of users. Alternatively (or in addition), in block 414, the platform application 104 may transmit the referral code to participant users specified in the request (e.g., to corresponding participant devices 108). Doing so allows the platform application 103 to receive connection requests by those participant devices 108 to connect to the critique session (in block 416).

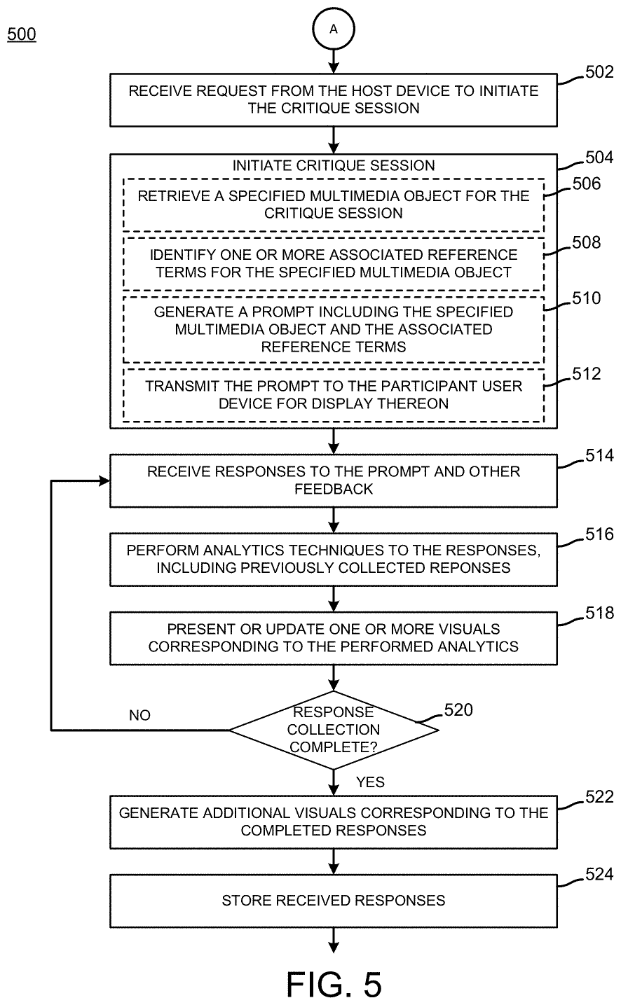

FIG. 5 illustrates a method 500 for managing a critique session in the backend based on communications from the host device 104 and the participant device 108. As shown, the method 500 begins in block 502, in which the platform application 103 receives a request from the host device to initiate a generated critique session.

In block 504, the platform application 103 initiates the critique session in response to the request. For example, to do so, in block 506, the platform application 103 retrieves a specified multimedia object (or subject for critique) for the session. For example, this object may have been specified and/or uploaded as part of the request by the host device to create the session. As another example, the object may have been uploaded by one of the participant devices invited to the critique session. In other cases, the request may specify a uniform resource locator from which to obtain the multimedia object. In block 508, the platform application 103 identifies one or more associated reference terms for the specified multimedia object. These reference terms may have previously been defined and submitted by the host device. In block 510, the platform application 103 generates a prompt including the specified multimedia object and the associated reference terms. The prompt may include the reference terms as associated with a given theme, such as an aesthetic, technique, or meaning to be assessed. The prompt may indicate a slider component and request that a participant score the reference terms based on an assessment of that reference term by manipulating the slider component on the user interface. The prompt may also include a text box for further comments. In block 512, the platform application 103 may transmit the prompt data to each participant user device for display thereon.

In block 514, the platform application 103 receives responses to the transmitted prompt and other feedback, including chat discussion input from user devices connected to the critique session. In block 516, the platform application 103 performs a variety of analytical techniques to the responses. For example, to do so, the platform application 103 gathers user input and aggregates the data. The platform application 103 may generate comparative data of a user response relative to other user responses in the aggregate. In an embodiment, the platform application 103 may also perform analytical techniques to the responses relative to previously stored responses for the subject of critique. In block 518, the platform application 103 presents or updates one more instructions for generating visuals for the generated analytics. In block 520, the platform application 103 determines whether the response collection is complete. For example, the response collection may be complete if the specified time window by the host device expires. If not, then the method 500 returns to block 514 to collect more responses. Otherwise, in block 522, the platform application 103 generates additional visualization data corresponding to the completed responses. In block 524, the platform application 103 may store the data (including chat logs) for future reference or growth assessment. Further, in an embodiment, once the metrics are presented, the platform application 103 may initiate (or continue) a chat session for the host and participant to discuss the analysis. Advantageously, the platform provides an interactive and social collaboration tool that helps in critiquing a subject (such as artwork) to receive real-time feedback. Further, the platform includes keyword integration to allow for better insight and can engage a class in active discussions on the platform. Stored application data can serve as a single point of truth for feedback on a given item as well as a source for identifying trends and gradual changes.

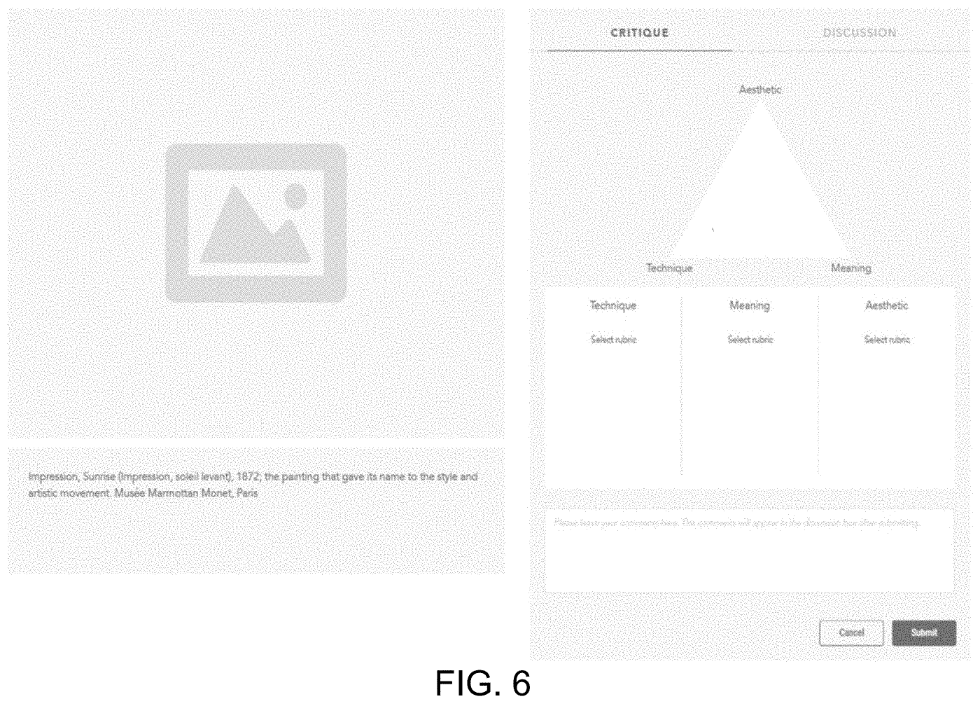

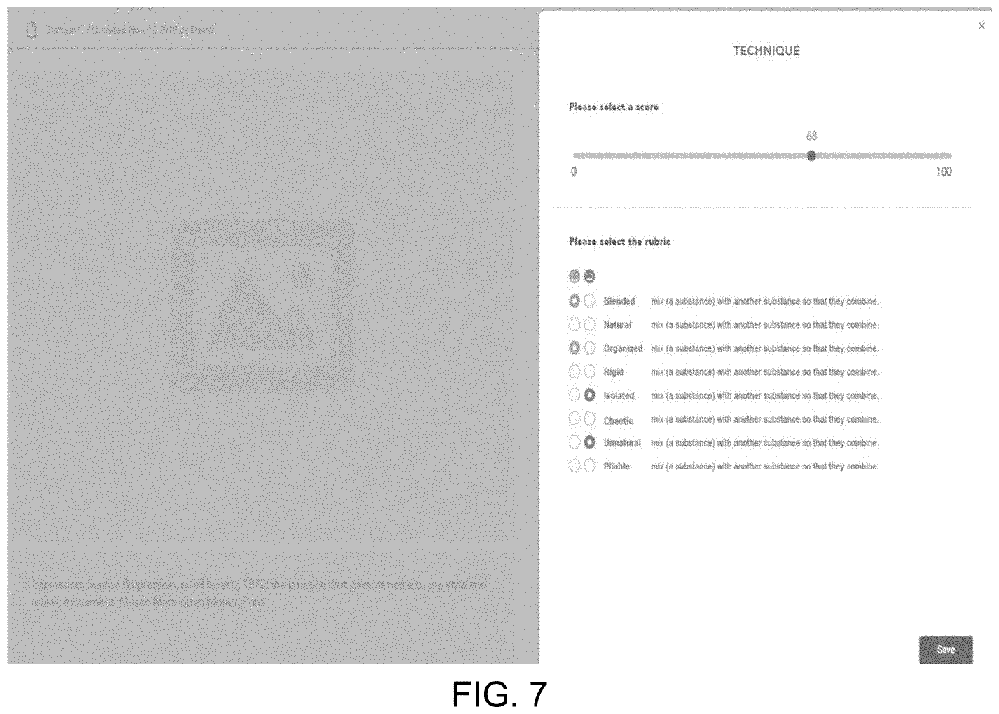

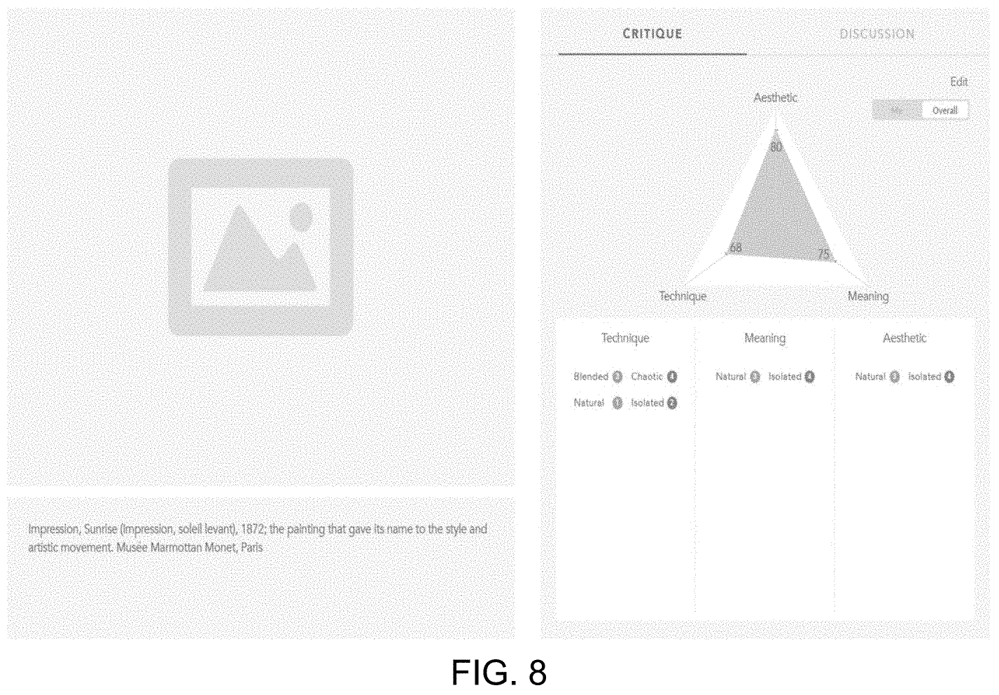

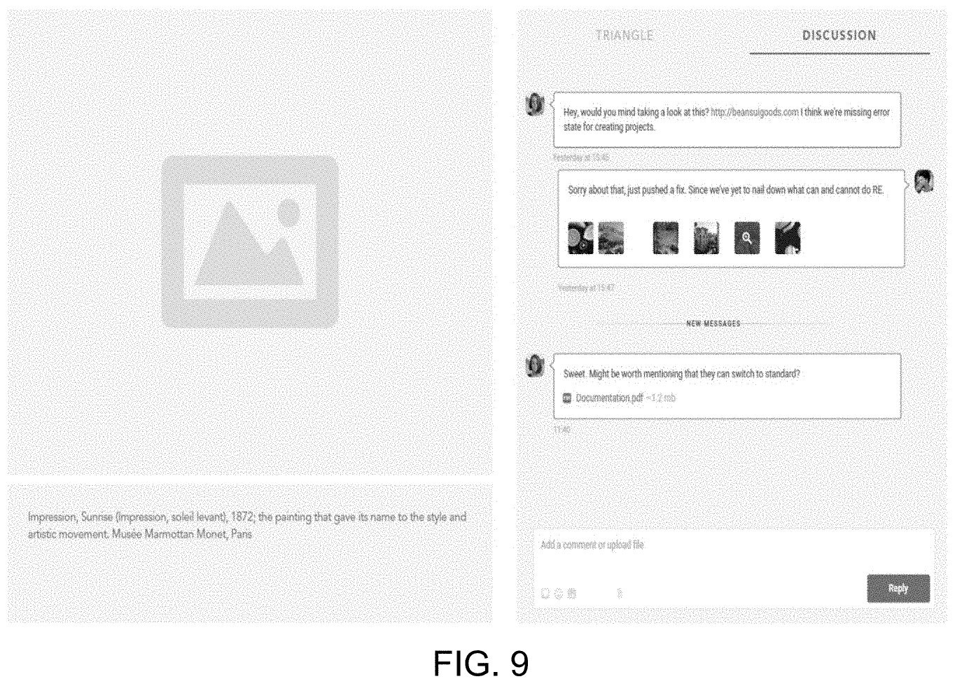

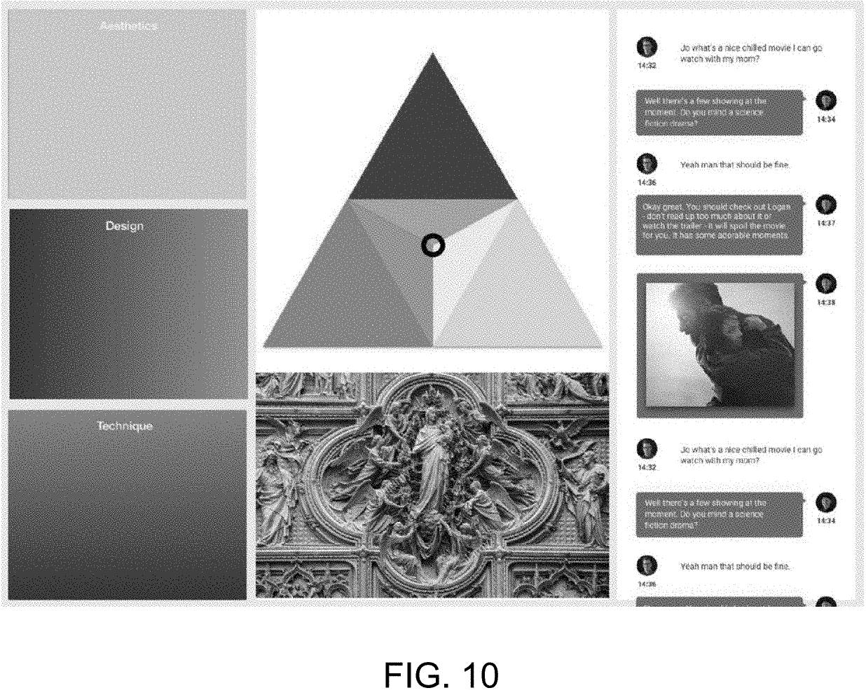

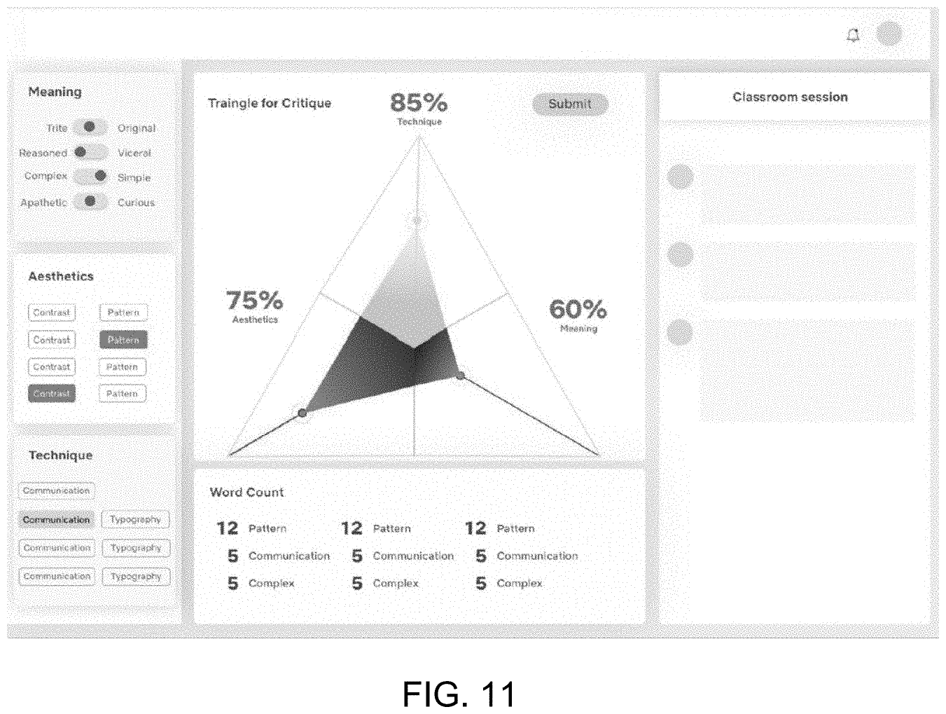

Referring now to FIGS. 6-11, examples of user interfaces that may be presented to a user of a device 300 are shown. FIG. 6 generally includes a panel for displaying a multimedia object on the left-hand side. On the right-hand side is a panel including a tab for critique and a tab for discussion. FIG. 6 displays the critique tab, which includes prompts set by the host. FIG. 7 expands on a critique prompt, which requests that a user score a technique used to create the subject. The prompt also lists reference terms alongside radio buttons allowing for a selection of a “happy face” or “frowning face” to associate with each term. FIG. 8 depicts a triangle chart displaying scoring for three aspects including aesthetic, technique, and meaning. Further, under each aspect, reference terms are listed based on user response. FIG. 9 displays a discussion tab showing interaction between participants in the critique. FIGS. 10 and 11 generally display another embodiment of a user interface that may be generated for the critique app.

1. A computer-implemented method for providing a critique session comprising:
transmitting, by a server, a multimedia object for critique and one or more terms associated with the multimedia object to an application executing on a device, wherein the device generates a prompt for the critique including the multimedia object and the one or more terms;
receiving, by the server and from the device, one or more feedback items in response to the prompt;
generating, by the server, a plurality of analytics associated with the one or more feedback items; and
transmitting, by the server, the plurality of analytics associated with the one or more feedback items.

2. The method of claim 1, wherein the device generates a visualization of the plurality of analytics for presentation on a user interface.

3. The method of claim 1, wherein the multimedia object is one of an image, audio, or video.

4. The method of claim 1, wherein the one or more feedback items includes responses associated with the one or more terms.

5. The method of claim 1, wherein the one or more feedback items includes chat messages from a user of the device.

6. The method of claim 1, further comprising storing the plurality of analytics on the server.

7. The method of claim 1, further comprising receiving, from a host device, a request to generate the critique session.

8. The method of claim 7, wherein the request includes the multimedia object and the one or more terms associated with the multimedia object.

9. The method of claim 7, wherein the request includes a specification of participant users for the critique session.

10. The method of claim 7, further comprising:
generating a session identifier; and
transmitting the session identifier to a host device.

11. The method of claim 10, wherein the session identifier is used by the device to connect to the critique session.

12. The method of claim 1, wherein the multimedia object is obtained by one of a host device or a participant device.

13. A server comprising:
a processor, and
a memory storing program code, which, when executed on the processor, performs an operation comprising:
transmitting a multimedia object for critique and one or more terms associated with the multimedia object to an application executing on a device, wherein the device generates a prompt for the critique including the multimedia object and the one or more terms;
receiving, from the device, one or more feedback items in response to the prompt;
generating a plurality of analytics associated with the one or more feedback items; and
transmitting the plurality of analytics associated with the one or more feedback items.

14. The server of claim 13, wherein the device generates a visualization of the plurality of analytics for presentation on a user interface.

15. The server of claim 13, wherein the multimedia object is one of an image, audio, or video.

16. The server of claim 13, further comprising receiving, from a host device, a request to generate the critique session.

17. The server of claim 16, wherein the request includes the multimedia object and the one or more terms associated with the multimedia object.

18. The server of claim 16, wherein the request includes a specification of participant users for the critique session.

19. The server of claim 16, wherein the operation further comprises:
generating a session identifier; and
transmitting the session identifier to a host device.

20. The server of claim 19, wherein the session identifier is used by the device to connect to the critique session.
